(19) United States
(12) Patent Application Publication
(10) Pub. No.: US 2026/0093993 A1
(43) Pub. Date: Apr. 2, 2026

(54) SYSTEMS AND METHODS FOR LAM SIMULATOR SELF LEARNING FRAMEWORK FOR AN AGENT WITH REAL-TIME EXPLORATION AND HIGH-QUALITY FEEDBACK AUTOMATION

(71) Applicant: Salesforce, Inc., San Francisco, CA (US)

(72) Inventors: Thai Hoang, Palo Alto, CA (US); Shirley Kokane, Palo Alto, CA (US); Jianguo Zhang, San Jose, CA (US); Tian Lan, Palo Alto, CA (US); Zuxin Liu, Palo Alto, CA (US); Ming Zhu, Palo Alto, CA (US); Jake Grigsby, Palo Alto, CA (US); Michael S. Ryoo, New York, NY (US); Shelby Heinecke, San Francisco, CA (US); Caiming Xiong, Menlo Park, CA (US); Huan Wang, Palo Alto, CA (US); Juan Carlos Niebles Duque, Mountain View, CA (US); Silvio Savarese, Palo Alto, CA (US)

(21) Appl. No.: 19/039,625

(22) Filed: Jan. 28, 2025

Related U.S. Application Data
(60) Provisional application No. 63/702,108, filed on Oct. 1, 2024.

(51) Int. Cl. G06N 3/0895

(52) U.S. Cl. CPC G06N 3/0895

(57) ABSTRACT

Embodiments described herein are directed to training a large action model (LAM) simulator framework. The LAM framework receives a content dataset associated with a task. This dataset includes the task name and at least one user command parameter. The LAM simulator framework identifies an abstract task based on the task name and determines the available tools for the task. It then generates a user command for an artificial intelligence agent, instructing it to complete the task using the abstract task and user command parameters. The AI agent is trained to execute the task over multiple iterations. An iteration involves creating a conversation data object from the user command, available tools, and prior conversation history, generating an action plan using a generative language model and the conversation data object, executing the actions in the plan using the environment and tools, and evaluating the actions.

### CROSS REFERENCE TO RELATED APPLICATIONS

This application is a nonprovisional of and claims priority under 35 U.S.C. 119 to U.S. Provisional Application No. 63/702,108 filed on Oct. 1, 2024, which is hereby expressly incorporated by reference herein in its entirety.

### TECHNICAL FIELD

The embodiments relate generally to machine learning systems for artificial intelligence agents, and more specifically to a large action model simulator framework.

### BACKGROUND

Artificial Intelligence (AI) conversation agents, commonly known as chatbots or virtual assistants, are being applied to a wide range of practical applications across various industries. In the customer service sector, AI agents handle user inquiries, provide support, and resolve issues 24/7, thus improving customer satisfaction and reducing operational costs. In the healthcare sector, AI agents offer initial consultations, answer health-related questions, and remind patients to take their medications. In the electronic-commerce sector, AI conversation agents assist with product recommendations, order tracking, and personalized shopping experiences. In the information technology (IT) support sector, AI agents guide users through troubleshooting steps and help users resolve software and hardware issues. Specifically, for network hazards, AI conversation agents can diagnose connectivity problems, suggest corrective actions, and provide step-by-step guidance to ensure network security and stability. The versatility and ability to handle diverse tasks make AI agents valuable tools in enhancing efficiency and user experience in various fields.

AI agents may employ a neural network based generative language model to generate an output. The output may be in the form of a text response or a series of actions to complete a complex task, such as network issue troubleshooting. Such generative language models receive a natural language input in the form of a sequence of tokens and generate a predicted distribution over a token space conditioned on the input sequence. The generated output tokens may form a text response or actions for completing the task. However, large action models (LAMs) for AI agents are generally limited by their reliance on supervised learning and manual data curation, which is time consuming and expensive. For example, current approaches for developing LAMs encompass a variety of techniques, including prompt engineering, integrating additional contextual information into agent prompts, Supervised Fine-Tuning (SFT), and Reinforcement Learning from Human Feedback (RLHF), among others. These approaches predominantly depend on supervised learning and manual data curation, which are both time-intensive and costly.

The concept of agent self-exploration has emerged as a promising avenue for reducing human labeling and annotation effort in the development of LAMs. Recent approaches, including those by ToolTalk, WebArena, and APIGen, have demonstrated the ability to generate high-quality data for agent learning and evaluation through automated means. However, these approaches still have some limitations. ToolTalk is limited to tasks that curated or filtered by humans. WebArena is constrained by a specific set of tasks and very limited action spaces within the web environment domain. APIGen is currently limited to a single-turn function calling and primarily focused on ensuring the correctness of function names and corresponding parameters.

On the other hand, existing open-source agent models such as Lemur, Agent-Gym, and xLAM still rely on rule-based methods and closed-world models like GPT-4o for collecting and filtering agent trajectories. Moreover, without a process for providing feedback or crafting the dataset, it is difficult to resolve the agent's issues for handling specific errors such as JSON parsing errors, tool hallucinations, and argument inaccuracies. This approach also limits the LAM's ability to explore a broader range of states based on past agent trajectories and to identify potential improvements.

### BRIEF DESCRIPTION OF THE DRAWINGS

FIG. 1 is a simplified diagram illustrating a large action model (LAM) simulator framework according to some embodiments.

FIGS. 2A-B are diagrams illustrating a content dataset, according to some embodiments.

FIG. 3 is a diagram of an example abstract task, according to some embodiments.

FIG. 4 is a diagram illustrating an example user command, according to some embodiments.

FIG. 5 is a diagram illustrating metadata corresponding to an example tool, according to some embodiments.

FIGS. 6A-C are diagrams of an example conversation data object that includes task instructions, available tools, an output format, a user command, and a conversation history, according to some embodiments.

FIG. 7 is a diagram of an example feedback response from an environment to an action generated by an agent large language model (LLM), according to some embodiments.

FIG. 8 is a diagram illustrating an example final response of an agent LLM, according to some embodiments.

FIG. 9 is a simplified diagram illustrating a computing device implementing a LAM simulator framework described in FIGS. 1-8 according to some embodiments.

FIG. 10 is a simplified diagram illustrating a neural network structure implemented in a LAM simulator framework, according to some embodiments.

FIG. 11 is a simplified block diagram of a networked system suitable for implementing the LAM simulator framework described in FIGS. 1-10 and other embodiments described herein.

FIG. 12 is an example logic flow diagram illustrating a method of completing a task based on the framework shown in FIGS. 1-11, according to some embodiments.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

As used herein, the term “Large Language Model” (LLM) may refer to a neural network based deep learning system designed to understand and generate human languages. An LLM may adopt a Transformer architecture that often entails a significant number of parameters (neural network weights) and computational complexity. For example, LLM such as Generative Pre-trained Transformer (GPT) 3 has 175 billion parameters (and newer GPT models have many more parameters), Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU). In some instances, large action models (LAMs) are a type of LLMs that has advanced capabilities in tool usage and function calling.

### Overview

The embodiments are directed to an LAM simulator framework for AI agent learning. LAM simulator framework enables AI agent models to interact with environments and tools in real-time, facilitating problem-solving and providing feedback useful for AI agent model learning at any point in the process, including both action-wise feedback and task-wise feedback. The LAM simulator framework includes a diverse collection of over multiple tasks with both action-wise feedback and task-wise feedback. Additionally, LAM simulator framework includes numerous tasks with high-quality feedback for action-wise feedback.

Embodiments described herein provide a number of benefits. For example, the design of the LAM simulator framework is highly unified, allowing for the seamless addition of new tasks, tools, environments, and reward criteria. The LAM simulator framework is suited to be used with any LAM or AI agent model for self-exploration purposes. This provides benefits in using the LAM simulator framework ants its AI agents in various industries, including diagnosing diseases and proteins, detecting fraud, detecting network malfunction, and many others.

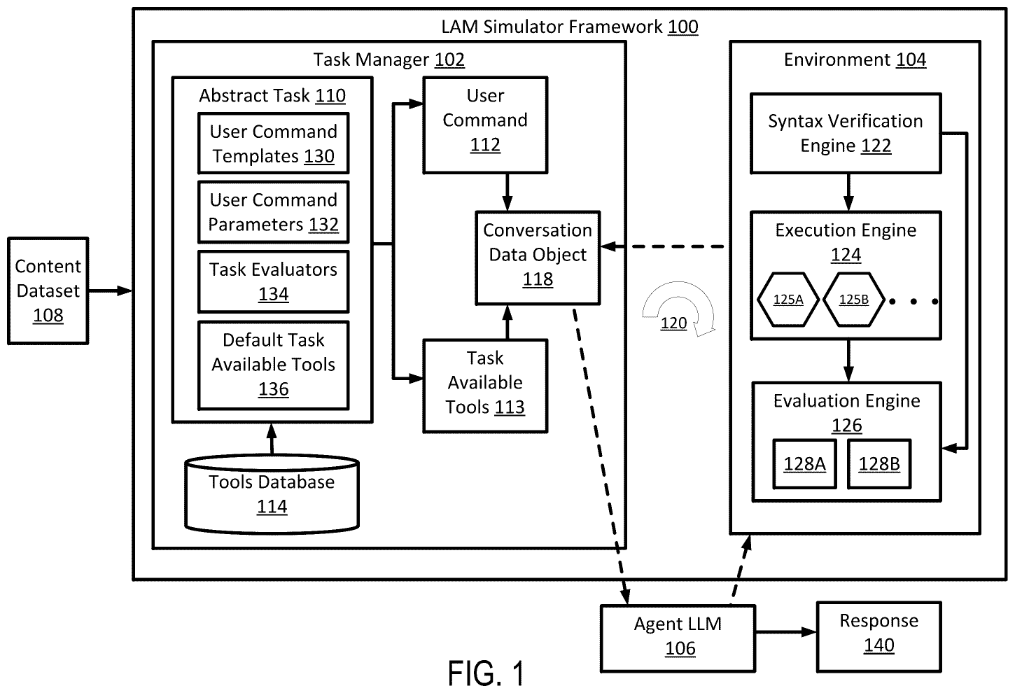

FIG. 1 is a simplified diagram illustrating a large action model (LAM) simulator framework 100 according to some embodiments. The LAM simulator framework 100 comprises a task manager 102 and environment 104 that interact with an agent large language model (LLM) 106. Although a single agent LLM 106 is shown, LAM simulator framework 100 may interact with multiple agents LLMs 106. Further, although the agent LLM 106 may implement an LLM model, the embodiments are not limited and may also apply to other language generative models. Agent LLM 106 may be an advanced artificial intelligence system designed to understand, generate, and interact with human language. Agent LLM 106 may be trained on vast amounts of text data, enabling agent LLM 106 to perform a wide range of language-related tasks such as answering questions, generating text, translating languages, and even engaging in conversations.

The LAM simulator framework 100 is designed to facilitate online exploration and provide high-quality feedback to generate agent data effectively. In particular, LAM simulator framework 100 may enable agent LLM 106 to interact with environments 104 and tools in real-time, facilitating problem-solving, and providing feedback useful for agent LLM 106 learning at any point in the process, including both action-wise feedback and task-wise feedback.

Task manager 102 may include an abstract task 110. Abstract task 110 may be one of multiple abstract tasks stored within or accessible to LAM simulator framework 100. Abstract task 110 may be used to generate user command 112 for a task that may be solved by agent LLM and identify task available tools 113. Task manager 102 may include user command templates 130, user command parameters 132, task evaluators 134, and default task available tools 136.

Environment 104 may include a syntax verification engine 122, execution engine 124, and evaluation engine 126. Syntax verification engine 122 may check the syntax of commands generated by the agent LLM 106. Execution engine 124 may execute the actions in the action plan generated by agent LLM 106 using one or more environments 125A-N. Evaluation engine 126 may evaluate response of agent LLM 106 that were generated based on the executed actions. In some instances, evaluation engine 126 may include intermediate action evaluator 128A and a final task evaluator 128B which may be accessed based on task evaluators 134 assigned to abstract task 110.

LAM simulator framework 100 may receive content dataset 108. Using content dataset 108, LAM simulator framework 100 may select abstract task 110 from multiple abstract tasks and use abstract task 110 to generate a user command 112 for content dataset 108. User command 112 may be a query in a natural language. The user command 112 may instruct the agent LLM 106 to perform a task. Agent LLM 106 may use task available tools 113 identified in abstract task 110 or in content dataset 108 in sequence to solve the task set forth by user command 112. During this process, agent LLM 106 may assess the current state of the task, make tool calls, and observe the environment 104's feedback. The process may continue over a configurable number of iterations, referred to as cycle 120, and until agent LLM 106 solves the task and generates final response 140 or reaches the step limit, e.g., configured number of steps N, where N is a positive integer, that indicates that a task cannot be solved.

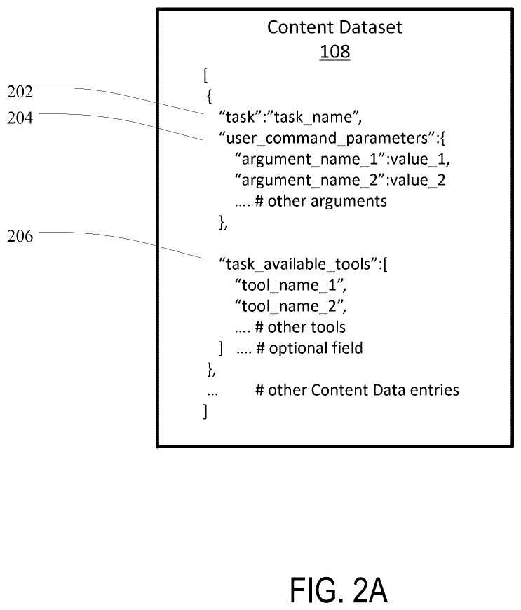

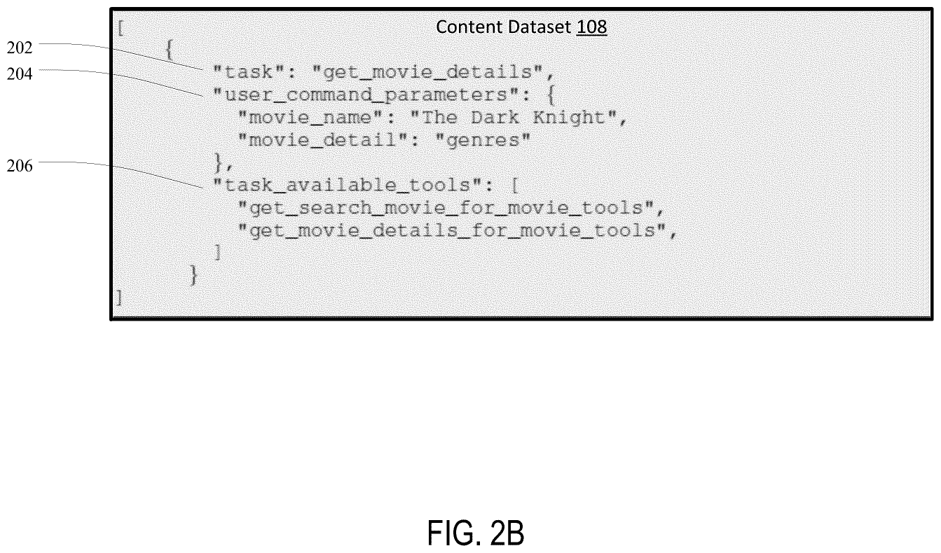

As discussed above, LAM simulator framework 100 may receive content dataset 108. Content dataset 108 may include information that LAM simulator framework 100 may use to create a task in a natural language that may be specified by user command 112. An example template for content dataset 108 is illustrated in FIG. 2A, according to some embodiments. As illustrated in FIG. 2A, content dataset 108 may include multiple components, including task name 202, user command parameters 204, and task available tools 206. The task name 202 may include a name of abstract task 110. Task manager 102 may use the task name 202 to select abstract tasks 110 from multiple abstract tasks accessible to LAM simulator framework 100. User command parameters 204 may be used to generate a user command 112 using available user command templates 130 within abstract task 110 and argument(s) and value(s) specified by user command parameters 204. Task available tools 206 include optional tools available to agent LLM 106 to solve the task. If task available tools 206 in content dataset 108 is left blank, the default tools set by the selected abstract task 110 may be assigned to agent LLM 106. FIG. 2B illustrates an example content dataset, according to some embodiments. The example content dataset in FIG. 2B may correspond to an abstract task 110 called “get_movie_details” and includes values for user command parameters 204 and names of the task available tools 206 that may be used to solve the task.

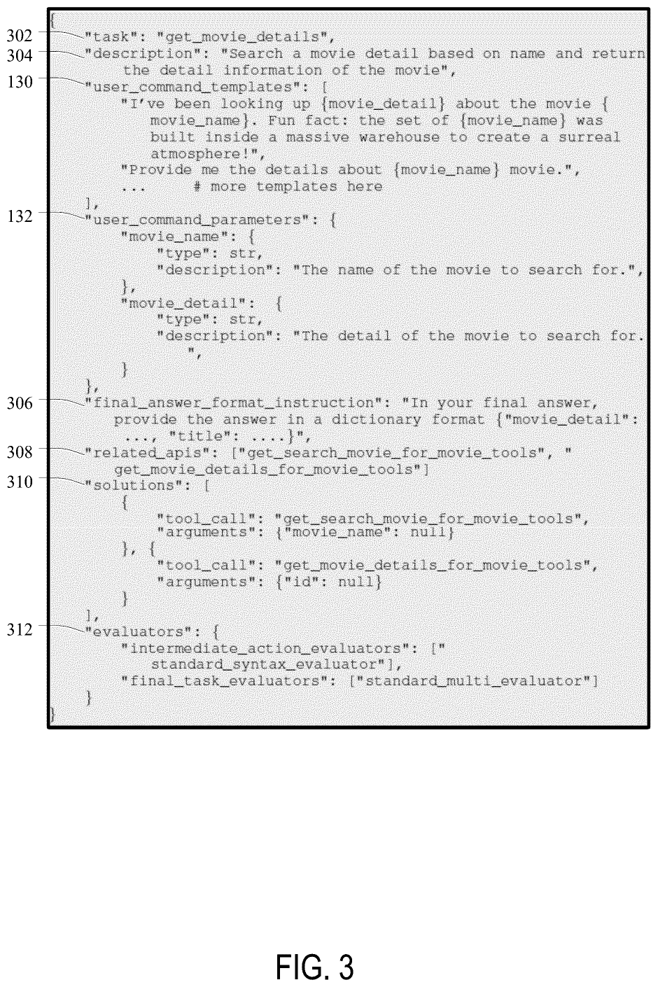

As discussed above, task manager 102 may include multiple abstract tasks. FIG. 3 is a diagram of an example abstract task, according to some embodiments. Abstract task 110 may include a task name 302, a description 304, user command templates 130, user command parameters 132, a final answer format instruction 306, related APIs 308, solutions 310, and evaluator names 312. Task name 302 may correspond to the name of abstract task 110. Description 304 may correspond to the description of abstract task 110. User command templates 130 may be templates included in abstract task 110 where values from content dataset 108 of user command parameters may be inserted. User command parameters 132 may be parameters included in abstract task 110 that may correspond to user command parameters 204 in content dataset 108 and whose values may be inserted into user command templates 130. The final answer format instruction may be an optional instruction indicating a format of final response 140 generated by agent LLM 106. Related APIs 308 may indicate names of the default task available tools 136 when content dataset 108 does not specify the tools. Solutions 310 may include possible solution paths to solve the task that may be implemented by the final task evaluator (as discussed below). Solutions 310 may include tool names and arguments, where arguments may include values that can be either specified as hard-coded values or null values. If values are specified as null, the values may be obtained from environment 104. Evaluator names 312 may be names of task evaluators 134 that may be used as intermediate action evaluators 128A and final task evaluators 128B by evaluation engine 126.

Going back to FIG. 1, once LAM simulator framework 100 receives content dataset 108, task manager 102 may select abstract task 110 to generate user command 112. For example, task manager 102 may extract a task name 202 from content dataset 108. Task manager 102 may then select abstract task 110 by matching the task name 202 to task names 302 of abstract tasks in LAM simulator framework 100. Within the selected abstract task 110, task manager 102 may search for user command template(s) 130 that match the user command parameters 204. In some instances, the match between user command parameters 204 and user command templates 130 may be exact. For example, task manager 102 may search for one of user command templates 130 in the selected abstract task 110 that includes user command parameters 132 that exactly match user command parameters 204 in content dataset 108. For instance, if content dataset 108 includes {“movie_name”: “The Dark Knight”} and {“movie_details”: “genres”} as its user command parameters 204, task manager 102 may search for a user command template in user command templates 130 within the abstract task 110 that includes parameters “movie_name” and “movie_details” and no others. Assuming one of user command templates 130 with user command parameters 132 that match user command parameters 204 in content dataset 108 is found (e.g., one of user command templates 130 that includes user command parameters “movie_names” and “movie_details”), task manager 102 may generate user command 112. If one of user command templates 130 is not found, task manager 102 may generate a not found error such that user command 112 is not created. Alternatively, task manager 102 may generate a new user command template that includes these parameters or select an existing user command template from user command templates 130 that is the closest match to the parameters, and then generate user command 112.

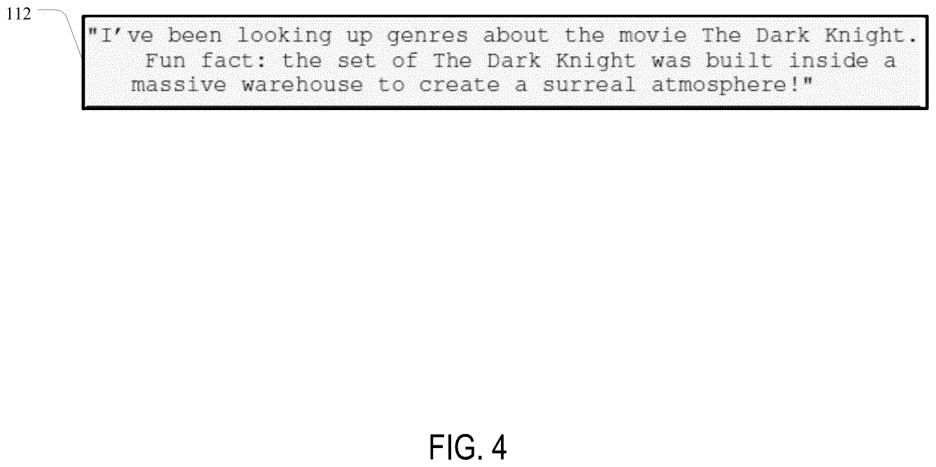

Suppose task manager 102 identifies one of user command templates 130. Suppose further, the identified one of user command templates 130 includes a prompt template that includes user command parameters 132. The example prompt template (also shown in FIG. 3) may be “I've been looking up {movie_detail} about the movie {movie_name}. Fun fact: the set of {movie_name} was built inside a massive warehouse to create a surreal atmosphere!” To generate user command 112, task manager 102 may substitute the arguments “movie_name” and “movie_detail” in the prompt template with corresponding values from content dataset 108. For example, task manager 102 may generate user command 112 that is “I've been looking up genres about the movie The Dark Knight. Fun fact: the set of The Dark Knight was built inside a massive warehouse to create a surreal atmosphere!” where the values “The Dark Knight” and “genres” are values included in content dataset 108 and substitute the user command parameters “movie_name” and “movie_detail”. FIG. 4 is a diagram illustrating an example user command 112 generated as discussed above.

Going back to FIG. 1, if content dataset 108 includes task available tools 206, task manager 102 may query tool metadata, such as tool descriptions and parameters that correspond to task available tools 206 from tools database 114. Task manager 102 may then generate task available tools 113 using task available tools 206 and corresponding metadata. If content dataset 108 does not include task available tools 206, task manager 102 may access default task available tools 136 listed in the abstract task 110. Task manager 102 may then query the tools database 114 to extract tool metadata for default task available tools 136 and may be task available tools 113 using default task available tools 136 and corresponding metadata.

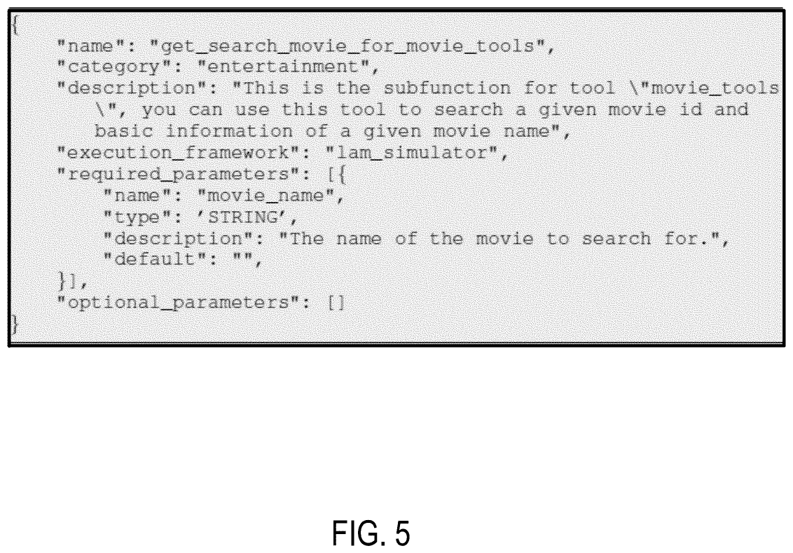

Tools database 114 may be a memory storage that stores multiple tools and tools metadata. The metadata may include information corresponding to the tool, such as tool name, tool category, tool description, the environment that may execute the tool (such as one of environments 125A-N), a list of required parameters, and a list of optional parameters. The tools themselves may be tools generated by one or more users, third-party applications, and the like. In some instances, tools may correspond to functions executed or interpreted using source code. FIG. 5 is a diagram illustrating metadata corresponding to an example tool, according to some embodiments. The example tool metadata illustrated in FIG. 5 is for a tool called the “get_search_movie_for_movie_tools.” The metadata for the tool may include the name of the tool, the category of the tool, the description of the tool, the execution framework, the required parameters, and the optional parameters. The name of the tool is provided in the “name” section and may be included in content dataset 108 or one of default task available tools 136 in abstract task 110. The “category” section specifies the category to which the tool belongs. A detailed explanation of the tool can be found in the “description” section. The “execution framework” section outlines the environment in which the tool can be executed, which could be the LAM simulator framework 100, environment 104 or any other environment. The “required parameters” section lists all the necessary parameters needed for the tool to function, and which may be generated by agent LLM 106 or included in abstract task 110. Additionally, the “optional parameters” section includes a list of parameters that can be used within the tool but are not mandatory.

Going back to FIG. 1, task manager 102 may generate conversation data object 118 from user command 112 and task available tools 113. Conversation data object 118 may include instructions for completing a task, task available tools 113, instructions for the output format, user command 112, and task evaluators 134. Additionally, conversation data object 118, after the first iteration, may receive the conversation history from environment 104. Once generated, task manager 102 may transmit conversation data object 118 to agent LLM 106.

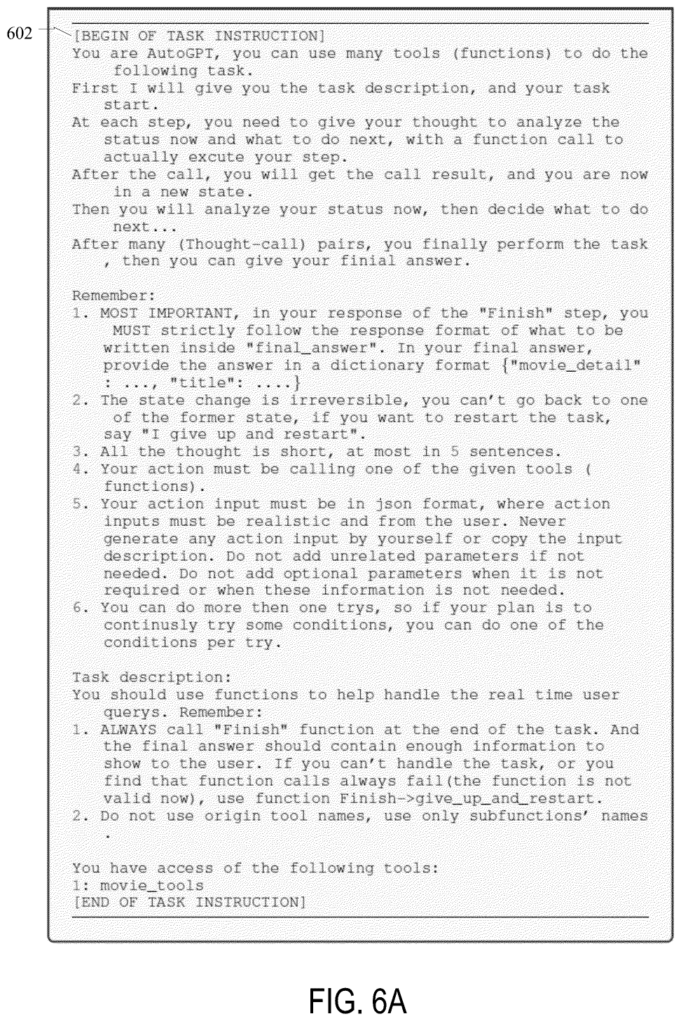

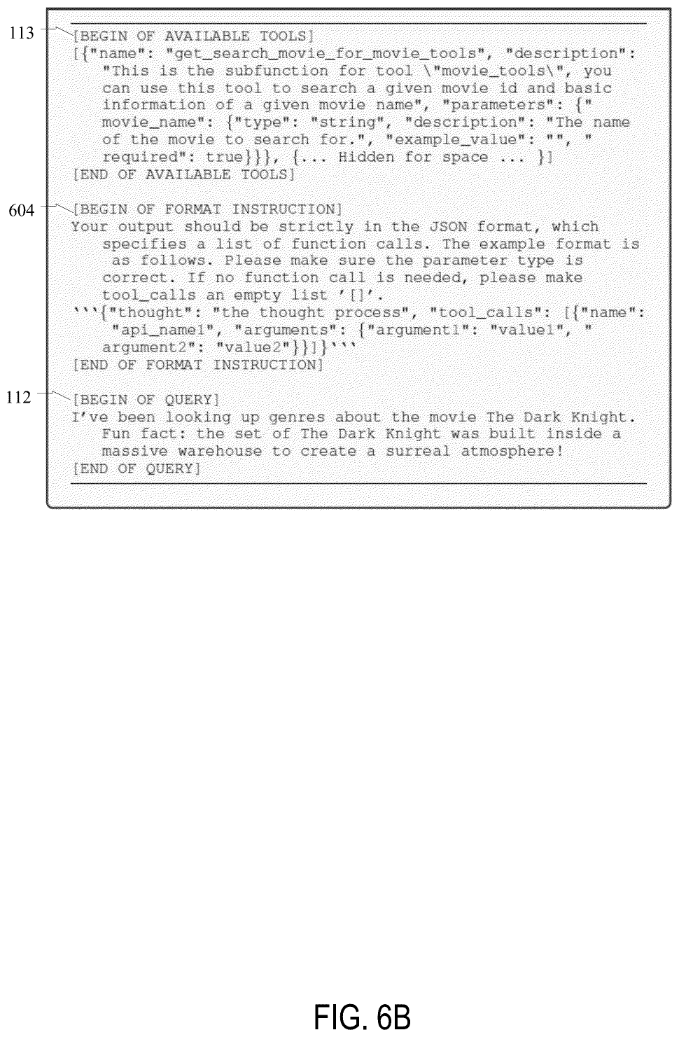

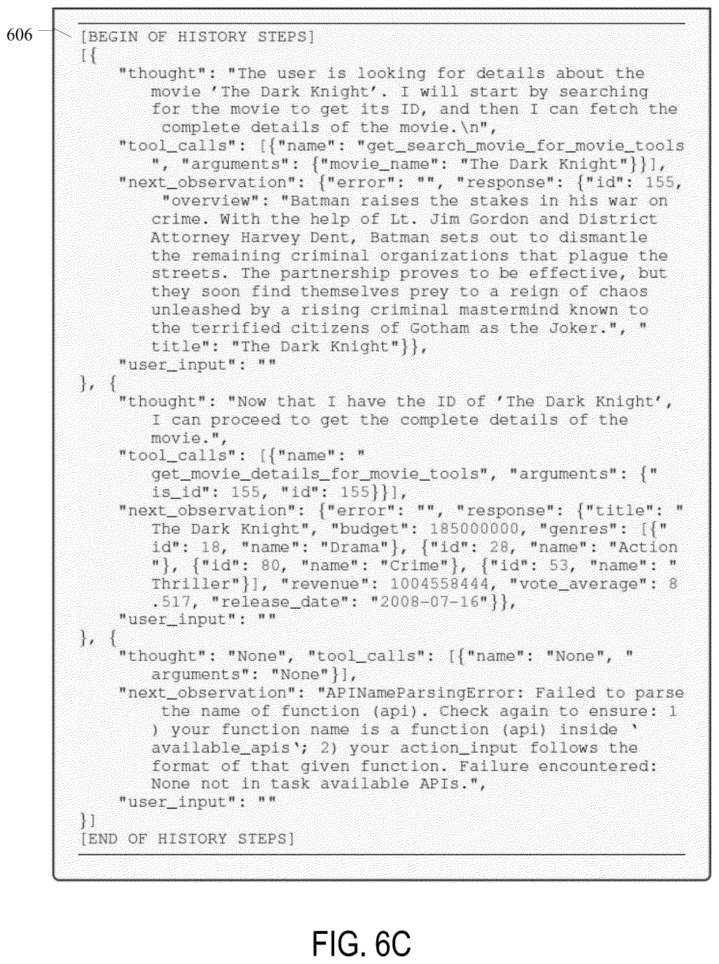

FIGS. 6A-C are diagrams of an example conversation data object 118 that includes task instructions, available tools, instructions for the output format, user command 112, and the conversation history, according to some embodiments. FIG. 6A illustrates a task instruction portion 602 of conversation data object 118 that is received by agent LLM 106 and instructs agent LLM 106 how to solve the task. FIG. 6B illustrates task available tools 113, user command 112, and a format of the output 604 that is final response 140 to the task or a text string generated using one or more intermediate iterations. FIG. 6C illustrates a conversation history 606 generated by previous iterations between agent LLM 106 and environment 104 in cycle 120.

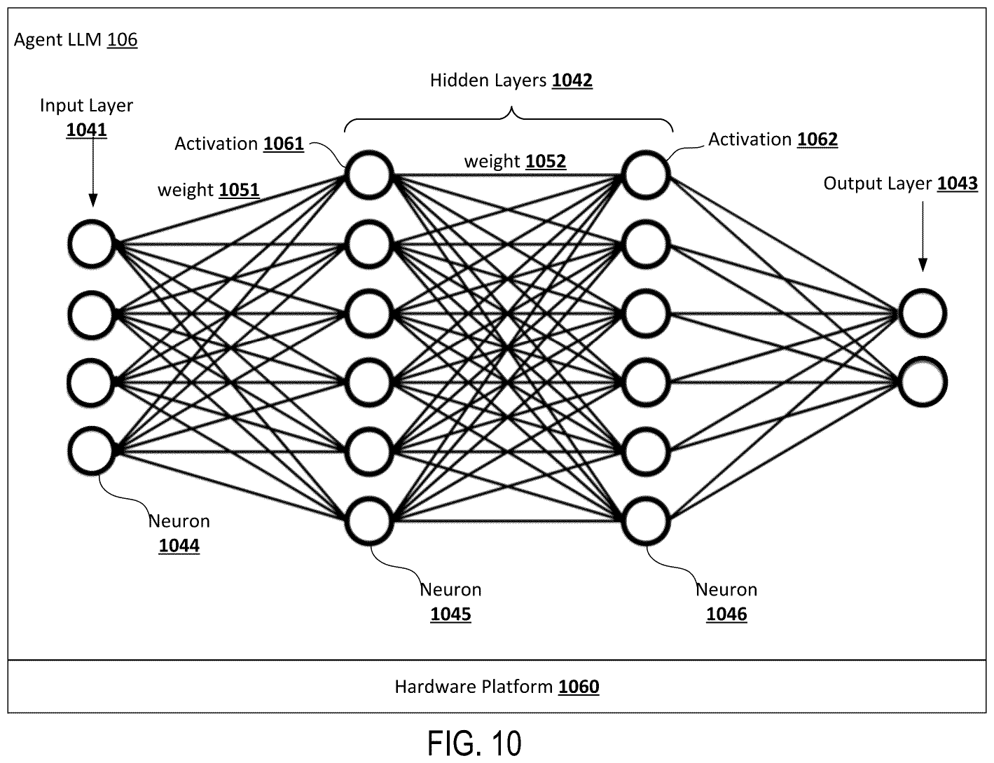

Agent LLM 106 may include a neural network conducive to natural language generation and processing. An example neural network may be a generative language model, such as a large language model designed to understand and generate human language and perform language related tasks, such as translation, summarization, question answering, and/or text generation. As will be discussed further in FIG. 10, a generative language model may be built using deep learning techniques, particularly neural networks with many layers, designed to process vast amounts of text data. Some examples of an LLM may be generative pre-trained transformer (GPT) models and Bidirectional Encoder Representations from Transformers (BERT) models, as well as their variants.

Agent LLM 106 may receive conversation data object 118 and use conversation data object 118 to generate actions and interact with the environment 104 to generate an answer for the task. Agent LLM 106 may interact with environment 104 and task manager 102 over multiple steps, collectively referred to as cycle 120, until the task is completed, or a maximum number of iterations is reached. During each iteration, LAM simulator framework 100 may invoke a number of steps, specified below.

The first step may include action generation and interaction. In this step, agent LLM 106 may produce actions based on its understanding of the task, task available tools 113, and the current context from the conversation history, all of which may be specified in conversation data object 118. Based on the conversation history, agent LLM 106 may generate an action plan that includes actions for the current iteration, specifies calls to the tools in task available tools 113 and parameters for the calls. Once the action plan is generated, agent LLM 106 may transfer the action plan to environment 104. If the agent LLM 106 determines it has enough information to provide the final answer to the user command 112, agent LLM 106 may invoke a special tool called “finish,” to wrap up the answer to the task and generate final response 140.

The second step may be syntax verification of the action(s) in the action plan. Syntax verification engine 122 in environment 104 may check that the command(s) in the action(s) generated by the agent LLM 106 are syntactically correct. Upon passing the syntax check, the actions are forwarded to an execution engine 124 in environment 104. If the action commands fail the syntax check, feedback is sent back to the agent LLM 106 to correct the syntax of the commands in the actions (not shown).

The third step may request execution. Execution engine 124 comprises multiple environments 125A-N (where N is an integer), including environment 125A and environment 125B shown in FIG. 1. One or more environments 125A-N may execute actions generated by agent LLM 106 by accessing task available tools 113.

The fourth step may evaluate the actions taken by agent LLM 106. Evaluation engine 126 may evaluate the agent LLM 106's actions during intermediate iterations and a final iteration for solving the task. Intermediate action evaluator 128A may assess each action generated by the agent LLM 106 during intermediate iterations of cycle 120. A particular intermediate action evaluator, such as intermediate action evaluator 128A may be specified in abstract task 110 in task evaluators 134. Intermediate action evaluator 128A receives agent LLM 106's generated text, which may be in a string format, and which may be based on the results from one or more environments 125A-N. For example, intermediate action evaluator 128A may verify that the string is correctly parsed and contains the required components, such as thought, tool calls, and tool arguments. If this passes, intermediate action evaluator 128A proceeds to the next step. Otherwise, intermediate action evaluator 128A raises a structure error. Next, intermediate action evaluator 128A ensures that the tool call(s) are valid by checking if the tool name(s) are included in the provided list of task available tools 113. If the tool check is passed, intermediate action evaluator 128A proceeds to the next step. Otherwise, intermediate action evaluator 128A raises a tool name error. Next, intermediate action evaluator 128A validates that the tool arguments are correct for the selected tool calls corresponding to tools in task available tools 123. For example, intermediate action evaluator may check if the required arguments are present, unknown arguments are not included, and that all arguments have a correct type. If this passes, intermediate action evaluator 128A marks the action as successful. Otherwise, intermediate action evaluator 128A raises a tool arguments error. The intermediate action evaluator 128A ensures that agent LLM 106 operates within the correct parameters throughout its task-solving process. By breaking down the evaluation into distinct checks, LAM simulator framework 100 may provide precise and actionable feedback at each iteration. If the error is raised, it may be recorded in the conversation history and may be corrected by agent LLM 106 during a subsequent iteration.

Final task evaluator 128B may be invoked when agent LLM 106 indicates that it has enough information to complete the task. Final task evaluator 128B may assess each action generated by the agent LLM 106 during a final iteration of cycle 120. The final iteration may occur on the last iteration of cycle 120 or when agent LLM 106 gathers sufficient information to generate an answer for the task in final response 140. Although one final task evaluator 128B is shown, there may be multiple final task evaluators in LAM simulator framework 100. Final task evaluator 128B may be specified in abstract task 110 as one of task evaluators 134. Final task evaluator 128B may receive user command parameters 204 and final response 140 generated by agent LLM 106 in a string format and verifies the final response 140. To verify the final response 140, final task evaluator 128B may perform its own evaluation for generating final response 140. For example, final task evaluator 128B may include a solution trajectory for each task that is not accessible by agent LLM 106, but which may be specified by solutions 310 in abstract task 110. Final task evaluator 128B may use the user command parameters 204 as the initial input and execute each tool in this solution trajectory sequentially to gather the necessary information to solve the task. The solution generated by final task evaluator 128B may be referred to as a gold label. If the final task evaluator 128B fails to generate the gold label, LAM simulator framework 100 may generate a special message indicating that this evaluation is invalid.

Once the gold label is generated, final task evaluator 128B compares the gold label with the agent LLM 106's final response 140. Final task evaluator 128B may use different methods to compare the gold label to the final response 140 for each task. Some example methods may include an exact match, structural match, or key information inclusion. The method for comparison may be included in the abstract task 110. If the final response 140 matches the gold label using the defined method, the final response 140 may include an indicator that is marked as passed. Otherwise, the indicator may be marked as failed.

The fifth step may be a feedback loop. The feedback loop may occur during iterations in cycle 120 that are not a final iteration or when evaluation engine 126 has determined that the final response 140 was not generated. During the feedback loop, environment 104 may pass feedback response, e.g., conversation history, from evaluation engine 126 to conversation data object 118 to be integrated with user command 112 and task available tools 113. Additionally, the newly generated actions from agent LLM 106 may also be appended to the conversation history for the next iteration in cycle 120. Subsequently, steps one through five may repeat until agent LLM 106 generates a solution for the task or a maximum number of iterations in cycle 120 is reached.

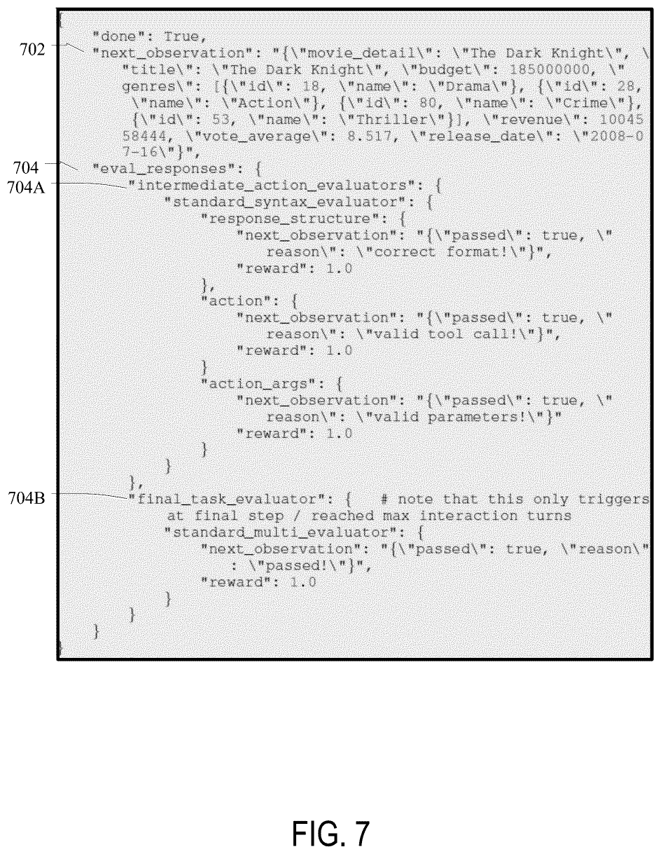

FIG. 7 is a diagram of an example feedback response from environment 104 to an action plan of agent LLM 106, according to some embodiments. The feedback response message may include an observation 702 and evaluator results 704, such as evaluator result 704A generated by intermediate action evaluator 128A, and/or evaluator result 704B generated by final task evaluator 128B.

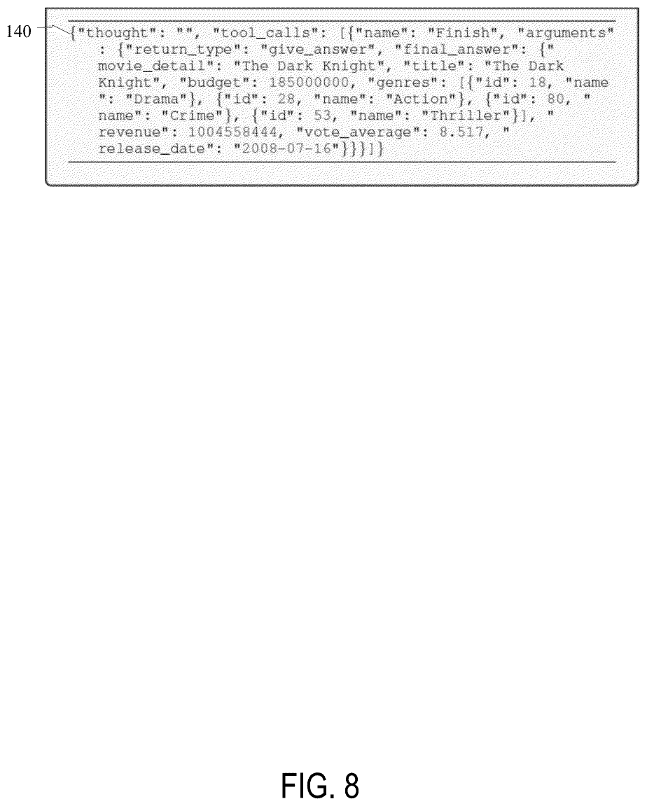

FIG. 8 is a diagram illustrating an example final response 140 of agent LLM 106, according to some embodiments.

Going back to FIG. 1, overall, LAM simulator framework 100 is designed to generate data with high-quality feedback for training agent LLM 106. It structures interactions using template-based user commands 112, employs a comprehensive task manager 102, and offers detailed automated feedback mechanisms. This ensures that the agent LLM 106 receives continuous and constructive feedback, enabling the agent LLM 106 to improve its task-solving capability without any human intervention, prompt engineering, labeling, reinforcement learning, and the like. LAM simulator framework 100 is a powerful and efficient tool for developing and refining agent LLM 106 and other similar agents that use LLMs.

### Computer and Network Environment

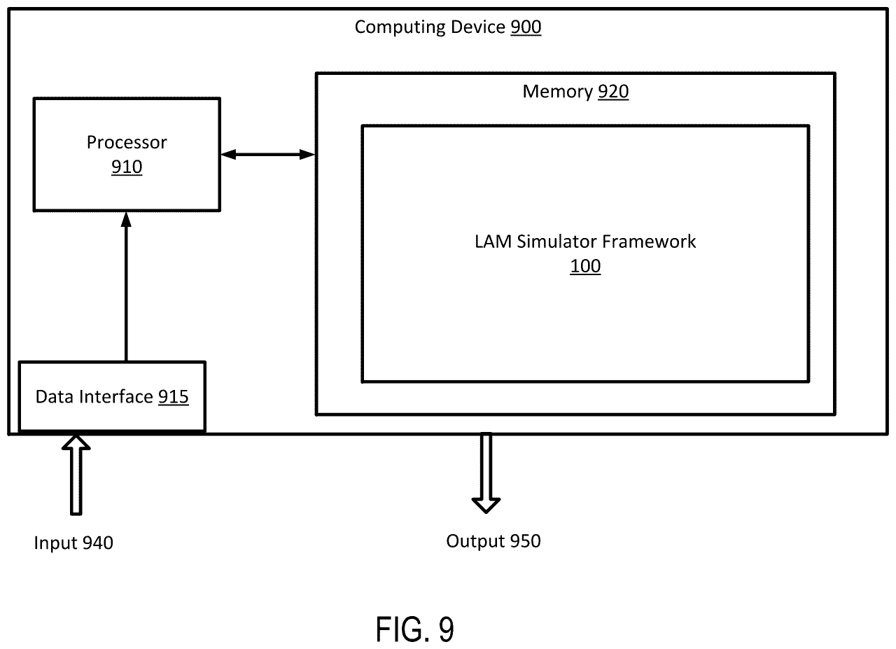

FIG. 9 is a simplified diagram illustrating a computing device implementing the LAM simulator framework 100 described in FIG. 1 according to one embodiment described herein. As shown in FIG. 9 computing device 900 includes a processor 910 coupled to memory 920.

Operation of computing device 900 is controlled by processor 910. And although computing device 900 is shown with only one processor 910, it is understood that processor 910 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 900. Computing device 900 may be implemented as a stand-alone subsystem, as a board added to a computing device, and/or as a virtual machine.

Memory 920 may be used to store software executed by computing device 900 and/or one or more data structures used during operation of computing device 900. Memory 920 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 910 and/or memory 920 may be arranged in any suitable physical arrangement. In some embodiments, processor 910 and/or memory 920 may be implemented on a same board, in a same package (e.g., system-in-package), on a same chip (e.g., system-on-chip), and/or the like. In some embodiments, processor 910 and/or memory 920 may include distributed, virtualized, and/or containerized computing resources. Consistent with such embodiments, processor 910 and/or memory 920 may be in one or more data centers and/or cloud computing facilities.

In another embodiment, processor 910 may comprise multiple microprocessors and/or memory 920 may comprise multiple registers and/or other memory elements such that processor 910 and/or memory 920 may be arranged in the form of a hardware-based neural network, as further described in FIG. 10.

In some examples, memory 920 may include non-transitory, tangible, machine readable media that includes executable code that when run by one or more processors (e.g., processor 910) may cause the one or more processors to perform the methods described in further detail herein. For example, as shown, memory 920 includes instructions for LAM simulator framework 100 that may be used to implement and/or emulate the systems and models, and/or to implement any of the methods described further herein. LAM simulator framework 100 may receive input 940 such as an input training data (e.g., user commands 112, content dataset 108, and/or conversation data object 118) via the data interface 915 and generate an output 950 which may be final response 140 or trained agent LLM 106.

The data interface 915 may comprise a communication interface, a user interface (such as a voice input interface, a graphical user interface, and/or the like). For example, the computing device 900 may receive the input 940 (such as a training dataset, content dataset 108) from a networked database via a communication interface. Or the computing device 900 may receive the input 940, such as actions from a user via the user interface.

Some examples of computing devices, such as computing device 900 may include non-transitory, tangible, machine readable media that include executable code that when run by one or more processors (e.g., processor 910) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 10 is a simplified diagram illustrating the neural network structure implementing some components of the LAM simulator framework 100 described in FIG. 1, according to some embodiments. In some embodiments, some sub-modules of LAM simulator framework 100 or agent LLM 106, such as a generating neural network model, e.g., an LLM within agent LLM 106, may be implemented at least partially via an artificial neural network structure shown in FIG. 10. The neural network comprises a computing system that is built on a collection of connected units or nodes, referred to as neurons (e.g., 1044, 1045, 1046). Neurons are often connected by edges, and an adjustable weight (e.g., 1051, 1052) is often associated with the edge. The neurons are often aggregated into layers such that different layers may perform different transformations on the respective input and output transformed input data onto the next layer.

For example, the neural network architecture may comprise an input layer 1041, one or more hidden layers 1042 and an output layer 1043. Each layer may comprise a plurality of neurons, and neurons between layers are interconnected according to a specific topology of the neural network topology. The input layer 1041 receives the input data (e.g., 1040 in FIG. 9), such as user commands 112, content dataset 108. The number of nodes (neurons) in the input layer 1041 may be determined by the dimensionality of the input data. Each node in the input layer represents a feature or attribute of the input.

The hidden layers 1042 are intermediate layers between the input and output layers of a neural network. It is noted that two hidden layers 1042 are shown in FIG. 10 for illustrative purpose only, and any number of hidden layers may be utilized in a neural network structure. Hidden layers 1042 may extract and transform the input data through a series of weighted computations and activation functions.

For example, as discussed in FIG. 1, the LAM simulator framework 100 or agent LLM 106 receives an input 1040, including user commands, and transforms the input into an output of actions. To perform the transformation, each neuron receives input signals, performs a weighted sum of the inputs according to weights assigned to each connection (e.g., 1051, 1052), and then applies an activation function (e.g., 1061, 1062, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 1041 is transformed into different values indicative data characteristics corresponding to a task that the neural network structure has been designed to perform.

The output layer 1043 is the final layer of the neural network structure. It produces the network's output or prediction based on the computations performed in the preceding layers (e.g., 1041, 1042). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the LAM simulator framework 100 or agent LLM 106 and/or one or more of their submodules may comprise the transformative neural network structure of layers of neurons, and weights and activation functions describing the non-linear transformation at each neuron. Such a neural network structure is often implemented on one or more hardware processors 1010, such as a graphics processing unit (GPU). An example neural network may be a large language model, generative pre-trained transformer model, bidirectional encoder representation from transformer model, and/or the like.

In one embodiment, the LAM simulator framework 100 or agent LLM 106 and their components may comprise one or more generative language models built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for input tokens to be processed through the multiple layers to generate an output in a Transformer architecture may entail hundreds of teraflops (trillions of floating-point operations) of computation.

In one embodiment, the LAM simulator framework 100 or agent LLM 106 and their submodules may be implemented by hardware, software, and/or a combination thereof. For example, the LAM simulator framework 100 or agent LLM 106 and their submodules may comprise a specific neural network structure implemented and run on various hardware platforms 1060, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 1060 used to implement the neural network structure is specifically configured based on factors such as the complexity of the neural network, the scale of the tasks (e.g., training time, input data scale, size of training dataset, etc.), and the desired performance.

In another embodiment, some or all of layers 1041, 1042, 1043 and/or neurons 1045, 1046, and operations there between such as activation functions 1061, 1062, and/or the like, of the LAM simulator framework 100 or agent LLM 106 and their submodules may be realized via one or more ASICs. For example, each neuron 1045 and 1046 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the LAM simulator framework 100 or agent LLM 106 may generate, by at least one ASIC (such as a TPU, etc.) performing a multiplicative and/or accumulative operation for a neural network language model, a next token based at least in prat on previously generated tokens, and in turn generate a natural language output representing the next-step action combining a sequence of generated tokens.

In one embodiment, the neural network included in LAM simulator framework 100 or agent LLM 106 and one or more of their submodules may be trained by iteratively updating the underlying parameters (e.g., weights 1051, 1052, etc., bias parameters and/or coefficients in the activation functions 1061 associated with neurons) of the neural network based on the loss. For example, during forward propagation, the training data, including user commands are fed into the neural network. The data flows through the network's layers 1041, 1042, 1043 with each layer performing computations based on its weights, biases, and activation functions until the output layer 1043 produces the network's output 1050. In some embodiments, output layer 1043 produces an intermediate output on which the network's output 1050 is based.

The output generated by the output layer 1043 is compared to the expected output (e.g., a “ground-truth”) from the training data, to compute a loss function that measures the discrepancy between the predicted output and the expected output. For example, the loss function may be a cross entropy, MMSE, etc. Given the loss, the negative gradient of the loss function is computed with respect to each weight of each layer individually. Such negative gradient is computed one layer at a time, iteratively backward from the output layer 1043 to the input layer 1041 of the neural network. These gradients quantify the sensitivity of the network's output to changes in the parameters. The chain rule of calculus is applied to efficiently calculate these gradients by propagating the gradients backward from the output layer 1043 to the input layer 1041.

In one embodiment, LAM simulator framework 100 or agent LLM 106 and their submodules may be housed at a centralized server (e.g., computing device 300) or one or more distributed servers. For example, one or more of LAM simulator framework 100 or agent LLM 106 and their submodules may be housed at external server(s). The different modules may be communicatively coupled by building one or more connections through application programming interfaces (APIs) for each respective module.

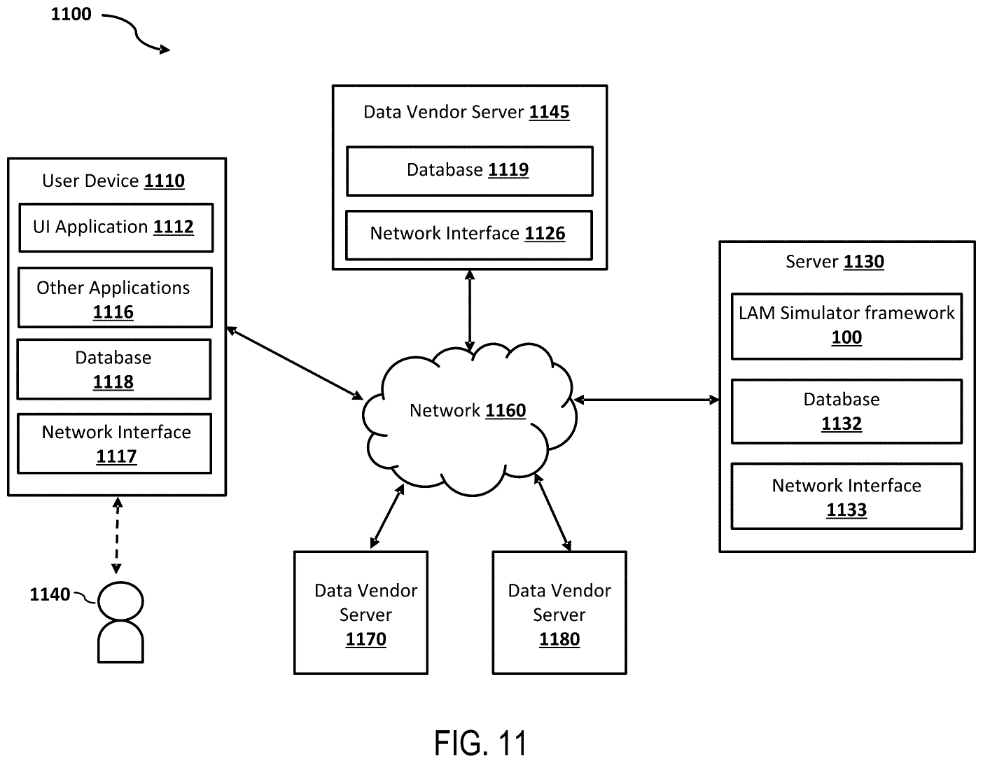

Additional network environment for the distributed servers hosting different modules and/or submodules may be discussed in FIG. 11.

During a backward pass, parameters of the neural network are updated backwardly from the last layer to the input layer (backpropagating) based on the computed negative gradient using an optimization algorithm to minimize the loss. The backpropagation from the output layer 1043 to the input layer 1041 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as unseen user commands.

Neural network parameters may be trained over multiple stages. For example, initial training (e.g., pre-training) may be performed on one set of training data, and then an additional training stage (e.g., fine-tuning) may be performed using a different set of training data. In some embodiments, all, or a portion of parameters of one or more neural-network model being used together may be frozen, such that the “frozen” parameters are not updated during that training phase. This may allow, for example, a smaller subset of the parameters to be trained without the computing cost of updating all the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in autonomous agent interaction.

FIG. 11 is a simplified block diagram of a networked system 1100 suitable for implementing the LAM simulator framework described in FIGS. 1-10 and other embodiments described herein. In one embodiment, system 1100 includes the user device 1110 which may be operated by user 1140, data vendor servers 1145, 1170 and 1180, server 1130, and other forms of devices, servers, and/or software components that operate to perform various methodologies in accordance with the described embodiments. Exemplary devices and servers may include device, stand-alone, and enterprise-class servers which may be similar to the computing device 900 described in FIG. 9, operating an OS such as a MICROSOFT® OS, a UNIX® OS, a LINUX® OS, or other suitable device and/or server-based OS. It can be appreciated that the devices and/or servers illustrated in FIG. 11 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 1110, data vendor servers 1145, 1170 and 1180, and the server 1130 may communicate with each other over a network 1160. User device 1110 may be utilized by a user 1140 (e.g., a driver, a system admin, etc.) to access the various features available for user device 1110, which may include processes and/or applications associated with the server 1130 to receive an output data anomaly report.

User device 1110, data vendor server 1145, and the server 1130 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 1100, and/or accessible over network 1160.

User device 1110 may be implemented as a communication device that may utilize appropriate hardware and software configured for wired and/or wireless communication with data vendor server 1145 and/or the server 1130. For example, in one embodiment, user device 1110 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 1110 of FIG. 11 contains a user interface (UI) application 1112, and/or other applications 1116, which may correspond to executable processes, procedures, and/or applications with associated hardware. For example, the user device 1110 may receive a message indicating agent actions and user commands from the server 1130 and display the message via the UI application 1112. In other embodiments, user device 1110 may include additional or different modules having specialized hardware and/or software as required.

In one embodiment, UI application 1112 may communicatively and interactively generate a UI for an AI agent implemented through the LAM simulator framework 100 (e.g., agent LLM 106) at server 1130. In at least one embodiment, a user operating user device YYY10 may enter a user utterance, e.g., via text or audio input, such as a question, uploading a document, and/or the like via the UI application 1112. Such user utterance may be sent to server 1130, at which LAM simulator framework 100 may generate a response via the process described in FIGS. 1-2. The LAM simulator framework 100 may thus cause a display of user commands, tasks, actions, at UI application 1112 and interactively update the display in real time with the user utterance.

In various embodiments, user device 1110 includes other applications 1116 as may be desired in particular embodiments to provide features to user device 1110. For example, other applications 1116 may include security applications for implementing client-side security features, programmatic client applications for interfacing with appropriate application programming interfaces (APIs) over network 1160, or other types of applications. Other applications 1116 may also include communication applications, such as email, texting, voice, social networking, and IM applications that allow a user to send and receive emails, calls, texts, and other notifications through network 1160. For example, the other application 1116 may be an email or instant messaging application that receives a prediction result message from the server 1130. Other applications 1116 may include device interfaces and other display modules that may receive input and/or output information. For example, other applications 1116 may contain software programs for asset management, executable by a processor, including a graphical user interface (GUI) configured to provide an interface to the user 1140 to view user commands, agent actions, tasks, etc.

User device 1110 may further include database 1118 stored in a transitory and/or non-transitory memory of user device 1110, which may store various applications and data and be utilized during execution of various modules of user device 1110. Database 1118 may store user profile relating to the user 1140, predictions previously viewed or saved by the user 1140, historical data received from the server 1130, and/or the like. In some embodiments, database 1118 may be local to user device 1110. However, in other embodiments, database 1118 may be external to user device 1110 and accessible by user device 1110, including cloud storage systems and/or databases that are accessible over network 1160.

User device 1110 includes at least one network interface component 1117 adapted to communicate with data vendor server 1145 and/or the server 1130. In various embodiments, network interface component 1117 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 1145 may correspond to a server that hosts database 1119 to provide training datasets to the server 1130. The database 1119 may be implemented by one or more relational database, distributed databases, cloud databases, and/or the like.

The data vendor server 1145 includes at least one network interface component 1126 adapted to communicate with user device 1110 and/or the server 1130. In various embodiments, network interface component 1126 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 1145 may send asset information from the database 1119, via the network interface 1126, to the server 1130.

The server 1130 may be housed with the LAM simulator framework 100 and its submodules described in FIG. 1. In some implementations, LAM simulator framework 100 may receive data from database 1119 at the data vendor server 1145 via the network 1160 to generate actions. The generated actions may also be sent to the user device 1110 for review by the user 1140 via the network 1160.

The database 1132 may be stored in a transitory and/or non-transitory memory of the server 1130. In one implementation, the database 1132 may store data obtained from the data vendor server 1145. In one implementation, the database 1132 may store parameters of the LAM simulator framework 100. In one implementation, the database 1132 may store previously generated actions, templates, user command parameter templates, abstract tasks, and the corresponding input feature vectors.

In some embodiments, database 1132 may be local to the server 1130. However, in other embodiments, database 1132 may be external to the server 1130 and accessible by the server 1130, including cloud storage systems and/or databases that are accessible over network 1160.

The server 1130 includes at least one network interface component 1133 adapted to communicate with user device 1110 and/or data vendor servers 1145, 1170 or 1180 over network 1160. In various embodiments, network interface component 1133 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 1160 may be implemented as a single network or a combination of multiple networks. For example, in various embodiments, network 1160 may include the Internet or one or more intranets, landline networks, wireless networks, and/or other appropriate types of networks. Thus, network 1160 may correspond to small scale communication networks, such as a private or local area network, or a larger scale network, such as a wide area network or the Internet, accessible by the various components of system 1100.

### Example Workflow

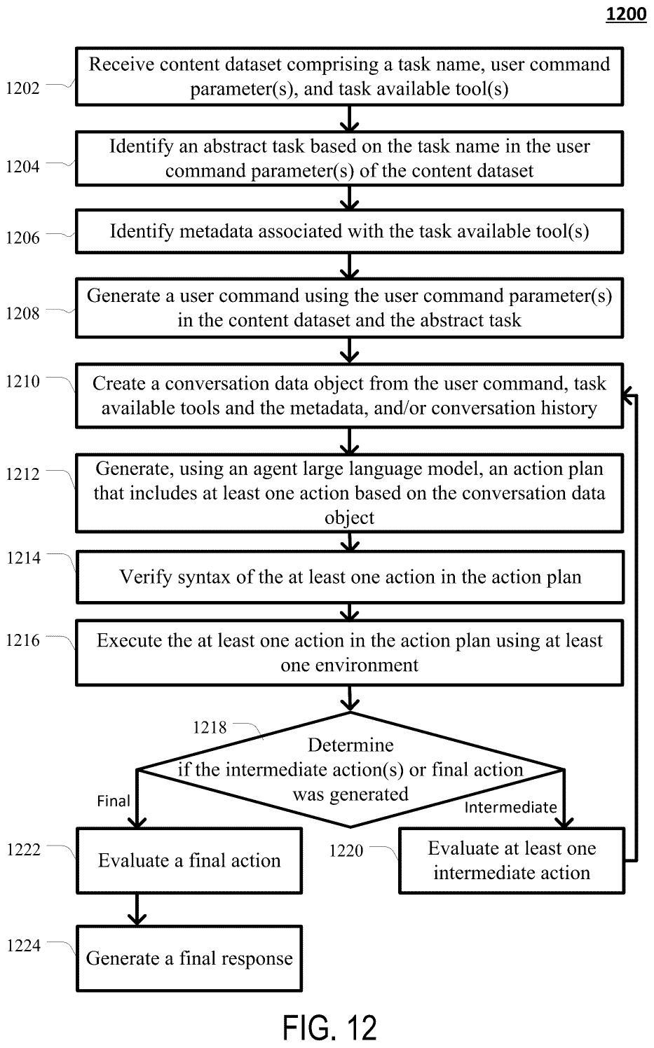

FIG. 12 is an example logic flow diagram illustrating a method 1200 based on the framework shown in FIGS. 1-11, according to some embodiments described herein. One or more of the processes of method 1200 may be implemented, at least in part, in the form of executable code stored on non-transitory, tangible, machine-readable media that when run by one or more processors may cause the one or more processors to perform one or more of the processes. In some embodiments, method 1200 corresponds to the operation of the LAM simulator framework 100 (e.g., FIGS. 1-11) that trains agent LLM 106.

As illustrated, the method 1200 includes a number of enumerated steps, but aspects of the method 1200 may include additional steps before, after, and in between the enumerated steps. In some aspects, one or more of the enumerated steps may be omitted or performed in a different order.

At step 1202, a content dataset is received. Content dataset 108 may include data from which a query in a natural language is generated and may include a task name 202, a listing of user command parameters 204, and/or a listing of task available tool(s) 206, if any.

At step 1204, an abstract task is identified. For example, task manager 102 may extract task name 202 from content dataset 108 and use the task name 202 to identify an abstract task 110 by comparing the task name 202 to the task names 302 of abstract tasks available, e.g., stored in or accessed by task manager 102.

At step 1206, metadata for task available tool(s) is identified. For example, content dataset 108 may include a list of task available tool(s) 206. From the list of task available tool(s) 206, task manager 102 may identify task available tool(s) 113 in the list and extract metadata for task available tool(s) 113. If the list of task available tool(s) 206 is not included in content dataset 108, task manager 102 may identify task available tools 113 from the list of default task available tools 136 included in abstract task 110 and extract the metadata corresponding to the default task available tools 136 from tools database 114.

At step 1208, a user command is generated. For example, task manager 102 may generate user command 112 by matching user command parameters 204 in content dataset 108 to user command parameters 132 in abstract task 110 and in user command template(s) of abstract task 110. Task manager 102 may then incorporate the values corresponding to user command parameters 204 into user command template(s) 130 in abstract task 110 in place of user command parameters 132.

At step 1210, a conversation data object is created. For example, task manager 102 may incorporate user command 112, task available tool(s) 113 and corresponding metadata, and conversation history 606 from previous iterations in cycle 120 into conversation data object 118. Conversation history 606 may provide context to agent LLM 106. Other parameters discussed in FIG. 6 may also be incorporated into conversation data object 118. Task manager 102 may transmit conversation data object 118 to agent LLM 106.

At step 1212, an action plan is generated. For example, agent LLM 106 may receive the conversation data object 118 and generates a plan for a current iteration of cycle 120. The plan may include one or more actions. If agent LLM 106 determines it has enough information to generate final response 140 to user command 112, agent LLM 106 incorporates a finish tool into the action plan, which indicates that final response 140 should be generated. Agent LLM 106 provides the generated plan to environment 104.

At step 1214, syntax of at least one action in the action plan is verified. For example, syntax verification engine 122 verifies syntax of at least one action in the action plan.

At step 1216, at least one action is executed. For example, the at least one action in the action plan may be executed by one or more environments 125A-N in execution engine 124.

At step 1218, a determination of whether the at least one action is a final action or intermediate action(s) is made. If the at least one action is an intermediate action, method 1200 proceeds to step 1220. If the at least one action is a final action, method 1200 proceeds to step 1222.

At step 1220, intermediate action(s) are evaluated. For example, intermediate action evaluator 128A may evaluate whether the string is correctly parsed and includes components such as thought, tool calls, and tool arguments, that the tool calls are valid, and that tool arguments are correct. Once the evaluation is complete, environment 104 generates conversation history for the current iteration and transmits the conversation history to task manager 102 for the subsequent iteration of cycle 120.

At step 1222, the final action is evaluated. In another example, final task evaluator 128B may evaluate whether the response to user command 112 is correct using a gold label. If so, method 1200 proceeds to step 1224 where agent LLM 106 generates final response 140 and cycle 120 ends.

In some instances, steps 1210-1220 may repeat until agent LLM 106 generates an action that indicates that agent LLM 106 determined final response 140 to the task or until a maximum number of iterations in cycle 120 is reached. At this point, agent LLM 106 may transmit the answer to task manager 102 and method 1200 completes (not shown).

In one embodiment, method 1200 is applicable in a variety of applications. For example, the LAM simulator framework 100 may be implemented in a diagnostic request in view of a medical record in a healthcare system, a curriculum design request in an online education system, a code generation request in a software development system, a writing or editing request in a content generation system, an IT diagnostic request in an IT customer service support system, a navigation request in a robotic and autonomous system, and/or the like. By performing method 1200, the LAM simulator framework 100 may improve technology in the respective technical field in healthcare and diagnostics, education and personalized learning, software development and code assistance, content creation, autonomous systems (such as autonomous driving, etc.), and/or the like.

In another example, LAM simulator framework 100 may identify an information technology (IT) anomaly relating to a usage of IT component(s) such as a network gateway, a router, an online printer, and/or the like, by performing method 1200 at an environment of a local area network (LAN). The agent LLMs 106 of LAM simulator framework 100 may receive an observation from the environment at which the next-step action is executed, and determine that the observation representing an information technology anomaly (e.g., a router failure, an unauthorized access attempt, a domain name system anomaly, and/or the like). In some implementations, the neural network based artificial agent may cause an alert relating to the information technology anomaly to be displayed at a visualized user interface. In this way, IT anomalies may be detected and alerted using the neural network based artificial agent in an efficient manner to improve network support technology.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth to provide a thorough understanding of the embodiments. It will be apparent, however, to one skilled in the art that some embodiments may be practiced without some or all these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method comprising:
receiving, via a data interface, at a large action model simulator framework, a content dataset associated with a task, wherein the content dataset includes a task name of the task and at least one user command parameter;
identifying an abstract task based on the task name in the content dataset;
identifying at least one task available tool;
generating a user command for an artificial intelligence agent using the abstract task and the at least one user command parameter in the content dataset, wherein the user command instructs the artificial intelligence agent to complete the task;
training the artificial intelligence agent to execute the task over a plurality of iterations, wherein an iteration in the plurality of iterations comprises:
creating a conversation data object from the user command and the at least one task available tool;
generating, using a generative language model in the artificial intelligence agent and the conversation data object, an action plan comprising at least one action;
executing the at least one action in the action plan using at least one environment and the at least one task available tool; and
evaluating the at least one action in the action plan.

2. The method of claim 1, wherein identifying the abstract task further comprises:
matching the at least one user command parameter in the content dataset to at least one user command parameter in the abstract task from a plurality of abstract tasks.

3. The method of claim 1, wherein generating the user command further comprises:
identifying a user command template in the user command templates of the abstract task that includes the at least one user command parameter in the content dataset; and
substituting at least one value corresponding to the at least one user command parameter into the user command template in place of the at least one user command parameter.

4. The method of claim 1, wherein identifying the at least one task available tool further comprises:
identifying the at least one task available tool using the content dataset or using at least one default task available tool in the abstract task.

5. The method of claim 1, wherein creating the conversation data object further comprises incorporating conversation history of the at least one action in the action plan from a previous iteration.

6. The method of claim 1, further comprising:
verifying syntax of the at least one action in the action plan.

7. The method of claim 1, wherein executing the at least one action in the action plan further comprises:
selecting the at least one environment using the abstract task; and
executing the at least one action in the action plan using the at least one task available tool in the at least one environment.

8. The method of claim 1, wherein the evaluating the at least one action in the action plan further comprises:
identifying a text string generated by the artificial intelligence agent;
verifying that the text string includes tool calls and tool arguments corresponding to the at least one task available tool;
verifying that the tool calls correspond to calls in the at least one task available tool; or
verifying that the tool arguments correspond to arguments in the calls in the at least one task available tool.

9. The method of claim 8, further comprising:
generating a conversation history based on the text string; and
incorporating the conversation history into the conversation data object in a subsequent iteration.

10. The method of claim 1, wherein the evaluating the at least one action in the action plan further comprises:
identifying the at least one action as a final action;
determining a final response for the final action;
determining a second response using a sequence of steps in the abstract task; and
verifying the final response with the second response.

11. The method of claim 9, further comprising:
terminating the plurality of iterations based on the verification.

12. The method of claim 1, further comprising:
terminating the plurality of iterations upon generating a final response to the task from the at least one action in the action plan or reaching a predetermined number of iterations.

13. A system comprising:
at least one processor; and
at least one memory coupled to the at least one processor and configure to store instructions that cause the at least one processor to perform operations, the operations comprising:
receiving at a large action model simulator framework, a content dataset associated with a task, wherein the content dataset includes a task name of the task and at least one user command parameter;
identifying an abstract task based on the task name in the content dataset;
identifying at least one task available tool;
generating a user command for an artificial intelligence agent using the abstract task and the at least one user command parameter in the content dataset, wherein the user command instructs the artificial intelligence agent to complete the task;
training the artificial intelligence agent to execute the task over a plurality of iterations, wherein an iteration in the plurality of iterations comprises:
creating a conversation data object from the user command and the at least one task available tool;
generating, using a large language model in the artificial intelligence agent and the conversation data object, an action plan comprising at least one action;
executing the at least one action in the action plan using at least one environment and the at least one task available tool; and
evaluating the at least one action in the action plan.

14. The system of claim 13, wherein to identify the abstract task, the operations further comprise:
matching the at least one user command parameter in the content dataset to at least one user command parameter in the abstract task from a plurality of abstract tasks.

15. The system of claim 13, wherein to generate the user command, the operations further comprise:
identifying a user command template in the user command templates of the abstract task that includes the at least one user command parameter in the content dataset; and
substituting at least one value corresponding to the at least one user command parameter into the user command template in place of the at least one user command parameter.

16. The system of claim 13, wherein to create the conversation data object the operations further comprise incorporating conversation history of the at least one action in the action plan from a previous iteration.

17. The system of claim 13, wherein to execute the at least one action in the action plan the operations further comprise:
selecting the at least one environment using the abstract task; and
executing the at least one action in the action plan using the at least one task available tool in the at least one environment.

18. The system of claim 13, wherein to evaluate the at least one action in the action plan the operations further comprise:
identifying a text string generated by the artificial intelligence agent;
verifying that the text string includes tool calls and tool arguments corresponding to the at least one task available tool;
verifying that the tool calls correspond to calls in the at least one task available tool; or
verifying that the tool arguments correspond to arguments in the calls in the at least one task available tool.

19. The system of claim 13, wherein to evaluate the at least one action in the action plan the operations further comprise:
identifying the at least one action as a final action;
determining a final response for the final action;
determining a second response using a sequence of steps in the abstract task; and
verifying the final response with the second response.

20. A non-transitory computer readable medium having instructions stored thereon, that when executed by a processor cause the processor to perform operations, the operations comprising:
receiving, via a data interface, at a large action model simulator framework, a content dataset associated with a task, wherein the content dataset includes a task name of the task and at least one user command parameter;
identifying an abstract task based on the task name in the content dataset;
identifying at least one task available tool;
generating a user command for an artificial intelligence agent using the abstract task and the at least one user command parameter in the content dataset, wherein the user command instructs the artificial intelligence agent to complete the task;
training the artificial intelligence agent to execute the task over a plurality of iterations, wherein an iteration in the plurality of iterations comprises:
creating a conversation data object from the user command and the at least one task available tool;
generating, using a generative language model in the artificial intelligence agent and the conversation data object, an action plan comprising at least one action;
executing the at least one action in the action plan using at least one environment and the at least one task available tool; and
evaluating the at least one action in the action plan.
